(19) United States
(12) Patent Application Publication
(10) Pub. No.: US 2003/0181781 A1
(43) Pub. Date: Sep. 25, 2003

(54) Device for the emulification of waste PVC and method therefor

(76) Inventor: Yuji Kohara, Hiroshima (JP)

Correspondence Address: BIRCH STEWART KOLASCH & BIRCH, PO BOX 747, FALLS CHURCH, VA, 22040-0747, US

(21) Appl. No.: 10/140,868

(22) Filed: May 9, 2002

(30) Foreign Application Priority Data
Mar. 22, 2002 (KR) 2002-15632

(51) Int. Cl. A62D 3/00

(52) U.S. Cl. 588/213; 588/226

(57) ABSTRACT

A device for the emulification of waste polyvinylchloride including a composing room for composing smashed and crushed polyvinylchloride powder from a crusher, a concentration pipe for cooling concentrating gasified chloride gas to a liquefied chloride gas, a storage tank for storing the liquefied chloride gas and a water container for containing water and an oil container for containing oil from the storage tank wherein the oil is delivered to a furnace of the composing room.

### BACKGROUND OF THE INVENTION

1. Field of the Invention

The present invention relates to a device for the emulification of the polyvinylchloride (hereafter “PVC”) and method therefor, and more particularly, to a PVC emulification device for effectively emulificating waste PVC so as recycling PVC in pollution free state, and method for the preparation thereof.

2. Description of Related Art

Various types of PVC emulification devices and methods for the preparation thereof are known in the art. Recently, many people have tried to get cycled PVC in a lot of studies. However, it is hard to get the recycled PVC from the waste PVC without pollution since several factors caused harm to the public have existed. Therefore, up to date, it is not succeeded to recycle the waste PVC without pollution.

Since plastics particularly, the PVC possess electric insulation property, heat stability, and stable chemical structure, the PVC has utilized in a lot of industrial fields and can not decompose easily. Therefore, even though many methods for decomposing, treating and recycling the waste PVC have disclosed in this time, we can not expect a good result. For example, when the waste PVC is treated by a high heating method, a lot of dioxines generated by this high heating method cause harm to public and can destroy an ecosystem.

### SUMMARY OF THE INVENTION

Accordingly, it is an object of the present invention to provide an improved PVC emulification device and method for the preparation thereof which eliminates the above problems encountered with conventional energy converting polar plates and method for the preparation thereof.

Another object of the present invention is to provide a PVC emulification device which includes a decomposing room, a concentration pipe communicated with the decomposing room at one end thereof, a storage tank communicated with the decomposing room at other end, and an oil container communicated with a furnace of the decomposing room and a waste water container whereby the recycled PVC is stored in the storage tank, and the emulification oil in the oil container can use as fuel after moving to the furnace of the decomposing room.

A further object of the present invention is to provide an improved method for the emulification of PVC which comprises the steps of crushing waste PVC in a crusher, composing the crushed PVC in a composing room with mica for accelerating decomposition by alpha wave generated from the mica, concentrating gasified chloride gas in a concentration pipe, storing the liquefied chloride from the concentration pipe in a storage tank, a waste water container for storing waste water from the storage tank, and storing oil from the storage tank in an oil container for sending the oil to a furnace of the decomposing room so as to use as fuel whereby the PVC emulification method is provided with a high yield and pollution free process.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a PVC emulification device according to the present invention;

### DETAILED DESCRIPTION OF THE PREFERRED EMBODIMENTS

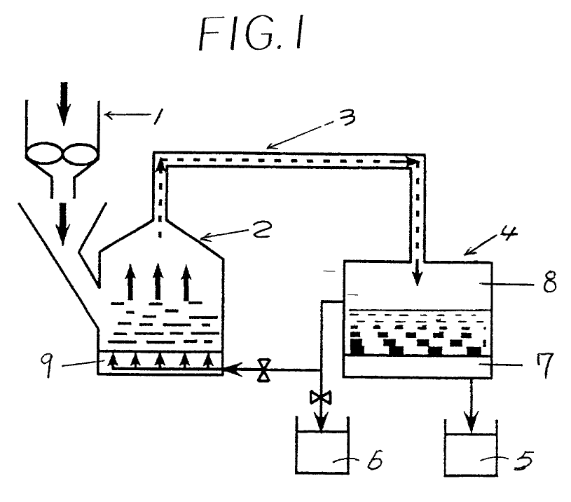

Referring now in detail to the drawings for the purpose of illustrating preferred embodiments of the present invention, the energy converting polar plate device as shown in FIG. 1 includes a crusher 1, a composing room 2 communicated with crusher 1, a storage tank 4, U-shaped concentration pipe 3 communicated with the composing room 2 and the storage tank at both ends thereof, a waste water container 5 connected to a lower part of the storage tank 4, and an oil container 6 connected to an upper part 8 of the storage tank 4 and to a furnace 9 of the decomposing room 2.

The crusher 1 is used for smashing and crushing waste PVC as raw material. At this time, it is not needed to remove impurities of the raw PVC. The smashed and crushed PVC powder can be delivered to the decomposing room 2. Thereafter, the furnace is provided with heat for decomposing the smashed and crushed PVC powder by putting the oil delivered from the oil container 6 into fire.

There are halogen derivative catalysts as a decomposition stimulator and mica as a resolving preparing in the composing room 2. The smashed and crushed PVC powder can be effectively decomposed by heat from the furnace 9 and alpha wave from the mica, and chloride gas is gasified in the decomposing room 2.

The gasified chloride gas produced from the decomposition of the raw PVC is cooled and concentrated through the concentration pipe 3 to produce liquefied gas. The liquefied gas is delivered to the storage tank 4. At this time, the water goes down and the oil goes up according to gravity thereof respectively. Also, the water is delivered to the waste water container 5 and the oil is delivered to the oil container 6. A part of oil in the oil container 6 is delivered to the furnace 9 of the decomposing room 2 for using in fuel. Accordingly, the waste PVC can be recycled without exit of any pollution material such as dioxines and chloride gas.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device for the emulification of waste polyvinylchloride comprising:
a crusher for smashing and crushing the waste polyvinylchloride;
a composing room communicated with said crusher; to produce gasified chloride gas;
a storage tank;
a concentration pipe communicated with said composing room and storage tank at both end thereof for being cooled and concentrated the gasified chloride gas to produce liquefied chloride;
a waste water container connected to a lower part of said storage tank; and
an oil container connected to an upper part of said storage tank and connected to a furnace of said composing room.

2. The device for the emulification of waste polyvinylchloride of claim 1, wherein said the concentration pipe has U-shaped configuration.

3. A method for the emulification of waste polyvinylchloride comprising the steps of:
(a) smashing and crushing waste polyvinylchloride to produce smashed and crushed polyvinylchloride powder;
(b) composing said smashed and crushed polyvinylchloride powder by heat in a furnace to produce gasified chloride gas;
(c) cooling concentrating said gasified chloride gas to produce liquefied chloride gas, oil and water; and
(d) delivering said oil to said furnace as fuel.

4. The method for the emulification of waste polyvinylchloride of claim 1, wherein said step (c) includes an upper part containing said oil, a middle part containing said liquefied chloride gas, and a lower part containing said water according to gravity thereof.
